(19) United States
(12) Patent Application Publication
(10) Pub. No.: US 2014/0156438 A1
(43) Pub. Date: Jun. 5, 2014

(54) Enhanced Online Dutch Auction with Seller Optimized Pricing Algorithms and Tabular Bidding Interface

(71) Applicant: Timothy Rex Beavers, (US)

(72) Inventor: Timothy Rex Beavers, Charlotte, NC (US)

(73) Assignee: Timothy Rex Beavers, Charlotte, NC (US)

(21) Appl. No.: 13/689,788

(22) Filed: Nov. 30, 2012

(51) Int. Cl. G06Q 30/08

(52) U.S. Cl. CPC G06Q 30/08
USPC 705/26.3

(57) ABSTRACT

The invention is an online Dutch auction where sellers can optimize the auction's pricing algorithm and related parameters to suit their needs and market conditions. Using the pricing algorithm, the invention creates BidBlocks for each price point, and places them in a tabular format or calendar where appropriate to simplify bidding. The invention always presents a “Buy It Now” option to shoppers to purchase the item at the current discount, or alternatively allows bidding on future price points. Active bidders are displayed in a Leaderboard which summarizes their status and relative placement. Numerous other features enhance the operability and usefulness of this invention for both buyers and sellers.

### CROSS REFERENCE TO RELATED APPLICATIONS

| | | |
|---|---|---|
| 2009/0076926 | August 2008 | Zinberg, et al |
| 2008/0172294 | July 2008 | McGuire |
| 7,835,957 | November 2010 | Kinney, et al |
| 6,609,112 | August 2003 | Boarman, et al |

### REFERENCE TO EARLIER FILED APPLICATION

This application claims priority to and the benefit of U.S. Provisional Application No. 61/556,149, titled “Online Dutch Auction with Seller Modifiable Parameters and Tabular Bidding Interface,” filed Dec. 2, 2011.

### BACKGROUND

A number of years before the internet rose to prominence, the inventor needed to sell a car. He put an ad in the newspaper saying that the price of the car started at $9,000 and reduced in price $100/day. Five days into the sale, the price was $8,500, and 4 people were expressing interest. One of them test drove the car and afterwards offered $8,000. The prospective buyer was politely told that he'd have to wait five more days until it reached that price, but that if it was unsold at that point, the car would be his for $8,000. He called later that night and agreed to the current price of $8,500, apparently deciding not to risk losing the sale to save an extra $500. The inventor would later discover that this method of selling items is known as a Dutch auction. Even though many years have passed, there are still no websites that effectively capture the exciting selling environment of that car sale, where the price was methodically reduced, and where potential buyers could express interest by bidding on their desired price points. Drawing from this inspiration, the inventor set forth to codify and document this idea which you see herein.

Simply put, the Dutch auction method of selling involves reducing the price of an item until a buyer is found. For every price reduction, the pool of interested buyers increases, thus increasing the odds of consummating a sale. Buyers face the common shopping dilemma of purchasing now or waiting for a better deal, but if they wait too long the item may sell out leaving them empty handed. Even though it efficiently matches buyers and sellers at fair prices, the application of Dutch auction strategies has not yet reached common acceptance in the online auction segment. What is lacking is a platform that makes Dutch auctions easy for sellers to use and tailor, as well as easy for shoppers to use and understand. If the Dutch auction functionality can be presented in an engaging and entertaining interface, it will gain greater acceptance and use as a viable marketplace tool.

### SUMMARY

This invention solves the Dutch auction mechanization that has troubled prior art with the introduction of practical tools for sellers and buyers. Sellers now will have complete control over their pricing schema and scheduling to best fit the market. Buyers can either buy now at the current price, wait for a better deal, or optionally they can place a bid on future price points. One of the challenges prior art has failed to overcome is allowing the shopper to visually see the price points and their relation to the passage of time. This invention solves this human interface dilemma by presenting all future price points as biddable blocks in a tabular graphical user interface (GUI), optimally arranged as a table or grid, stack or queue, or calendar. Bidders are displayed both in the block they have bid on and on a leaderboard which shows their relative status for this sale.

### BRIEF DESCRIPTION OF THE DRAWINGS

FIG. 1 is an image of the typical configuration of the invention residing on a server and its relation to the database and assorted network interface devices and computers.

FIG. 2 is a flowchart depicting the logic, options and decisions of posting an item up for sale on the invention.

FIG. 3 is an image showing just one of the many possible graphical depictions of an active item for sale on the invention.

FIG. 4 is an image showing the BidBlocks arranged in a simple width-modifiable table and with one BidBlock revealing more details through an expanded data display.

FIG. 5 is an image showing the BidBlocks arranged in a stack/queue format.

FIG. 6 is an image showing the BidBlocks arranged in a calendar format.

FIG. 7 is a flowchart depicting how bids are processed in the invention, assuring that sales are awarded to bids in a FIFO manner based on execution time, and that the available quantity is adjusted properly.

### INVENTION DESCRIPTION

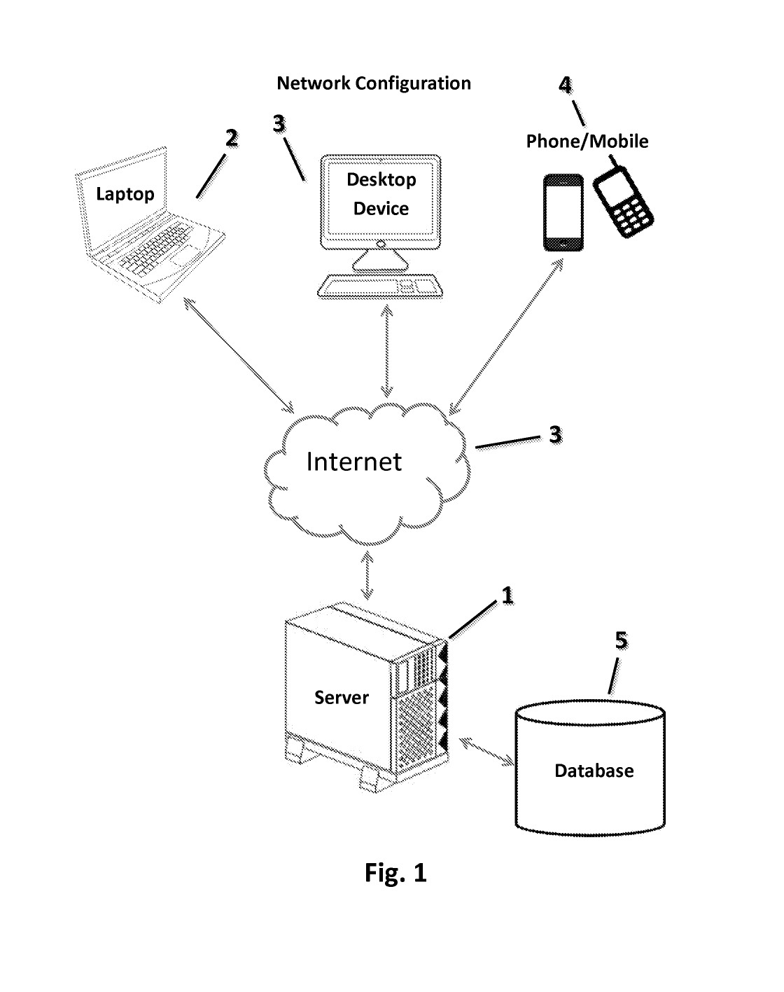

The invention embodiment (FIG. 1) resides on an internet server 1, and stores auction data in numerous tables on a relational database 5. Users and/or site visitors will use their choice of internet browser on their choice of interface device, such as a laptop 2, desktop computer 3 or mobile device 4 to communicate and pass parameters via the internet 3 with the invention on the server.

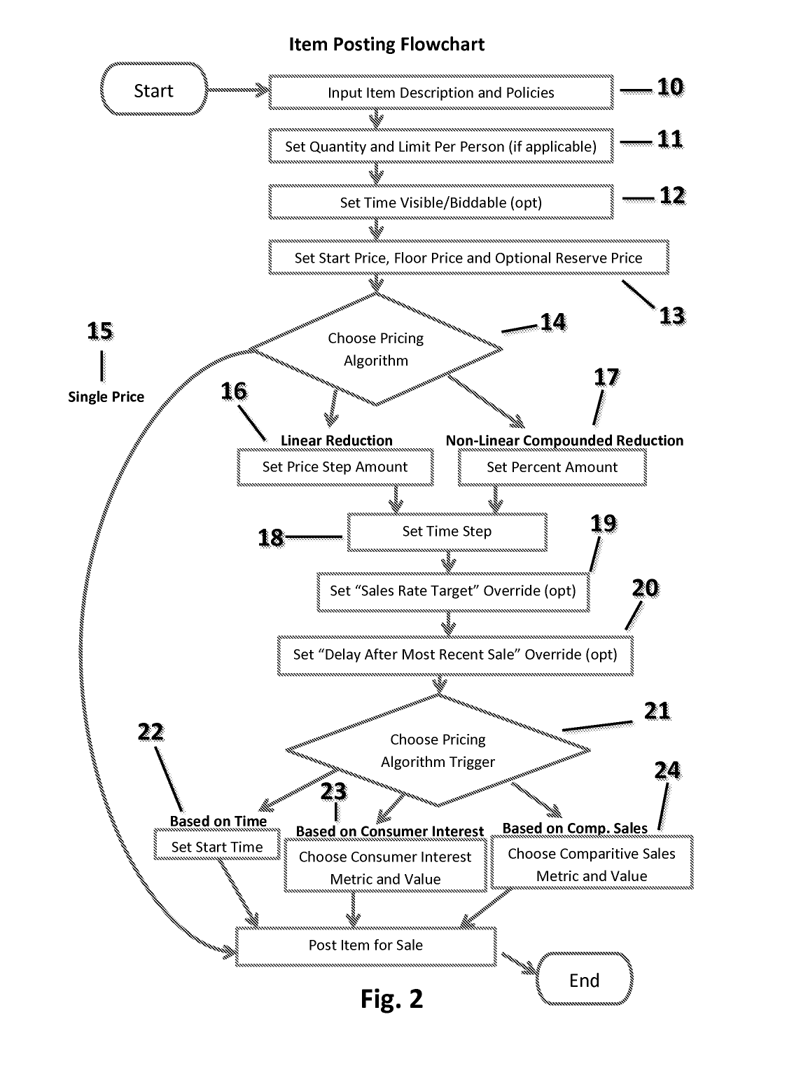

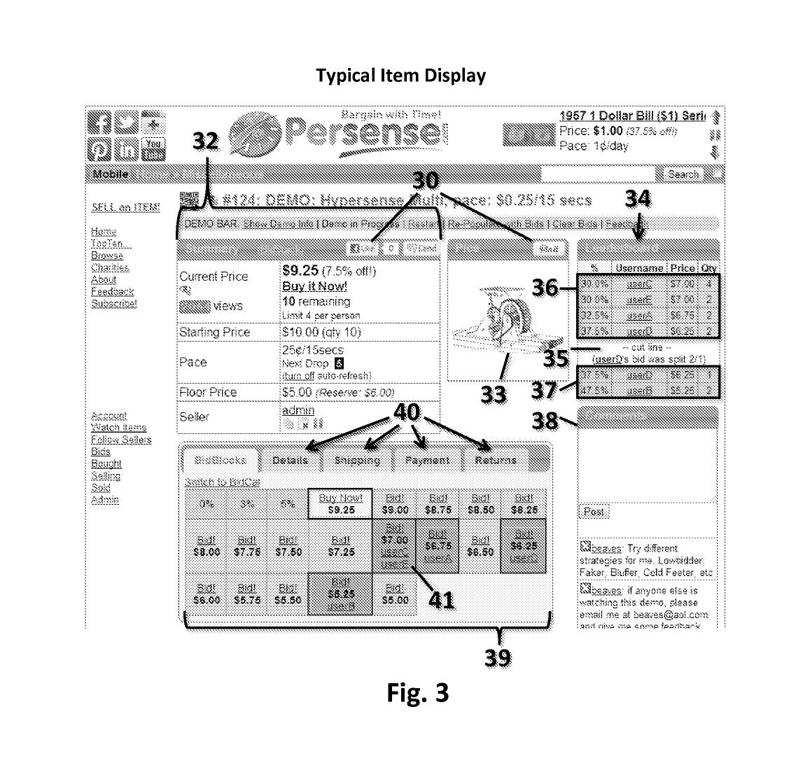

Using the invention's item posting interface (FIG. 2), the seller posts a single or multiple item (lot) Dutch auction meeting the sellers objectives and requirements. The basic page of the newly created posting (FIG. 3) has all of the relevant item information as well as a link to “Buy It Now.” The invention also creates the GUI BidBlocks for each possible price point, which can programmatically be constructed to display any information related to that price point, as well as enable shoppers to perform certain functions related to that price point, most notably bidding. At any time during the auction, users can see all of the currently active bids by glancing at the arranged BidBlocks or Leaderboard.

Selling

Sellers will come from the pool of registered users. If a user decides to sell an item, the user posts a myriad of information describing the item, to include title and physical description fields, shipping charges and other various instructions and policies 10, quantity available and purchase limit per person 12. Further, the seller must decide on some additional Dutch auction parameters, granting the seller complete control over the pricing scheme tailored to the item, market forces and seller objectives.

Selling Parameters

The seller can decide when the item optionally becomes ‘visible’ to bidders. This allows an item to be entered into the database, but only become visible and biddable at a specified time in the future, giving the sellers an ability to stagger item entries into the marketplace.

The seller chooses a starting price 13.

The seller chooses an optional Reserve price 13. Temporary sales struck below this price may be optionally rejected by the seller. This allows the seller to factor in other considerations before accepting or denying the buyers bid, such as travel distance, payment options, buyer fitness, market forces, etc.

The seller chooses a Floor price 13, where the pricing schema ceases when it is reached. Automatic pricing will not continue lower than this price.

The seller chooses the pricing schema optimized for seller objectives and market conditions 14. This may be, but is not limited to:
A. A constant price with no price reductions 15. Sellers may still manually edit this price, but it will not be automatically adjusted. Hence, there can be no bidding, and “Buy It Now” will be the only option.
B. A simple linear price reduction (step price amount per unit of time, or $/t) 16. The step price amount will be selected by the seller and may be any desired amount between ½ of the starting price to 1/1000^{th} of the starting price. As opposed to prior art, this invention's step price amount need not be tied to a percentage of the starting price, unless the seller of course elects to purposefully do so. This allows the seller much more pricing flexibility to suit objectives or buyer conceptualization. For instance, a 10% linear reduction series of [$99.00, $89.10, $79.20, $69.30] can be messy to display and lacks simplicity. Whereas a $10 linear reduction series such as is allowed by this invention of [$99, $89, $79, $69] is cleaner to display and easier for users to understand the pattern. This is especially true of higher priced sales such as real estate, where buyers and sellers prefer pricing items in nice round amounts. Further, the chosen time interval 18 can theoretically, with this invention, be any amount of seconds. However for ease of inputting and practicality, the units will be programmatically limited to major time divisions that make the most sense, i.e. 15 s, 30 s, 1 min, 5 min, 20 min, 1 hour, 3 hours, 6 hours, 12 hours, 1-6 days, 1-4 weeks.
C. A non-linear compounded price reduction 17. This amounts to a percent reduction per unit of time (%/t), where the next price block is a designated percent less than the previous. A 10% compounded price reduction algorithm would result in a series such as: [$100, $90, $81, $72.90 . . . ]. The time step 18 will be chosen as in the above algorithm.

With the core pricing algorithm chosen by the seller and the resulting in the array of price points established, the seller may elect to allow for some additional automatic features to temporarily override or work in conjunction with the core algorithm. Two such automatic features are described below and claimed later:
A. A “Sales Rate Target” optional override for multiple item auctions where the current price point is adjusted up or down so as to maintain a desired rate of purchase. This could be helpful to maintain sales volumes to match production rates. For instance, a seller wishes to sell 5 widgets a day to match the production capacity of his factory. He chooses unweighted average triggers of 2/day on the low side and 8/day on the high side. If his sales fall below 2/day, the original algorithm will be reinstated, reducing the price on schedule until the pace of 5/day returns, where the pricing will then hold steady. If sales exceed 8/day, the price will rise one BidBlock, and will continue to rise until the desired 5/day sales pace returns. The triggers causing pricing adjustments could be chosen from a number of possible metrics to include hi and low sales boundaries of either realtime, averaged, or weighted averaged sales. With this option, restocking may be allowed so sellers can continue this auction without interruption. This override has tremendous utility and could be easily configured to automatically solve many of the supply/demand/pricing problems that confront merchants, most notably seasonal sales.
B. A “Delay After Most Recent Sale” optional override 20 for multiple item auctions will trigger any time a sale is struck, resetting the clock for the next price reduction. This effectively only allows a resumption of the chosen reduction algorithm in case of no selling activity in a certain amount of time. For example, if a widget has not sold in the last 12 hours, a price reduction to the next BidBlock will occur and the pricing algorithm will resume. This could be used to keep prices steady if demand is steady, yet adaptive and competitive if demand drops.

The seller chooses a trigger to commence the pricing algorithm 21. This may be, but is not limited to:
A. A specified time in the future 22.
B. When a specified number of users expresses interest via ‘watching’ or ‘add to favorites’ or bidding 23.
C. When the aggregate number of items being bid meets or exceeds the total number of items available, optionally in combination with number of bidders above 23.
D. Competitive price comparisons, i.e. if the item's current price floats above a moving statistical average sales price 24.
E. Combination of the above or a mathematical formula dictated by the seller.

After all of the information is input, the item is ready for display and sale (FIG. 3). All of the pricing data is used to calculate the finite series of price points and their associated BidBlocks.

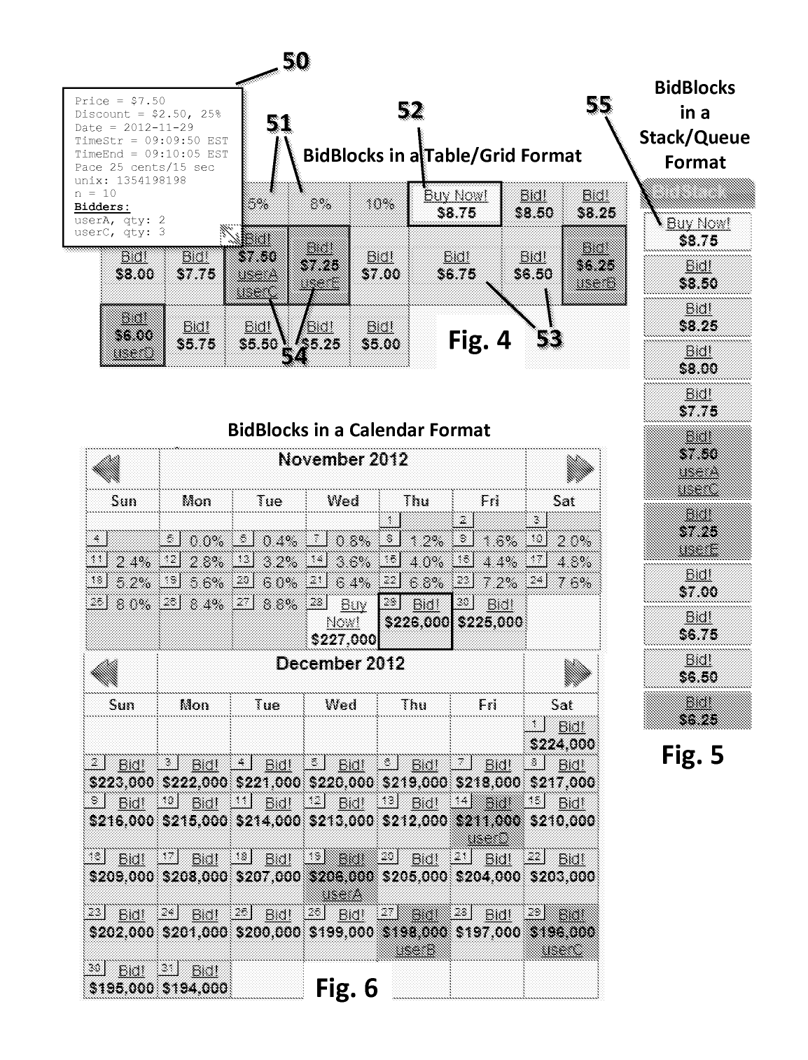

The BidBlocks (FIGS. 4, 5, 6) will contain all of the pertinent calculable data regarding that price point: Price, percent off, block start/stop times, duration, ordinal (‘n’) number, bidders plus their quantity requested, etc. 50. Stylistic differences in color and border will be used to visually differentiate certain BidBlocks base on whether they are past 51, current 52, future 53 or occupied 54 BidBlocks. The BidBlocks are constructed to display minimum core data as a default, and then to display additional information upon mouse click, hover or other means 50. The exact choice of what data points to display will vary depending on the needs of the website, the stylistic choices of the programmer, and the current technology available. The constructed The BidBlocks can then be amalgamated and tabularized in a myriad of different formats to suit the seller, the item, and other environmental factors. The versatility and usefulness of the BidBlock method of graphically depicting Dutch auction price points is a significant improvement over prior art. Humans instinctively recognize understand patterns, and the inherent patterns in a Dutch auction are prominently displayed with this invention and thus can be more easily and quickly comprehended and assessed by buyers.

An infinite assortment of BidBlock tabular views are possible with this embodiment, with three such specific examples provided below:
1. The simple table or BidGrid (FIG. 4). This optimizes the BidBlock appearance when there are a manageable number of BidBlocks, probably below 100. Row size in the BidGrid can be optimized to further enhance pattern recognition. For example, 5 BidBlocks per row would display an auction with $2 step price such that each row is equivalent to a $10 reduction.
2. The stacked column or queue (FIG. 5). This format allows for the current “Buy It Now” bid block to remain prominently at the top of the BidBlocks 35, and displays only the future BidBlocks stacked below. At the conclusion of each BidBlock time window, the expired block disappears and the remaining blocks all move up one.
3. The calendar format or BidCal (FIG. 6). This format gives the user a familiar calendar representation of BidBlocks allowing for better temporal conceptualization. It allow the user to easily determine what the price will be 2 months from now, or 3 weeks from now. This format is typically optimum when there are less than 3 or 4 price points occurring per day. This calendar embodiment of the BidBlocks is yet another improvement over prior art, allowing users to quickly comprehend the effect of time on the auction in question. Most Dutch auctions tend to fall into the category of a single price reduction per day, so this embodiment is expected to reach a wide audience and popular acceptance.

Sellers will have the option to automatically announce their posted items to Facebook, Pinterest, Twitter or other social sites, allowing their followers to be notified of the activity 30.

Sellers will have the ability to pause auctions that have not been bid on yet, which takes them off the market and the item becomes neither biddable nor visible. When resumed, the auction continues where it left off and the BidBlock time spans are adjusted accordingly. This capability will be useful to sellers that want to for whatever reason to put the auction on hold and to resume at a later date.

A freeze mechanism will be optionally available for Sellers to freeze the auction after a sale is struck, whereby if the sale is not fully consummated by a certain time, the auction may be resumed without losing the bids of other bidders. This feature is predicted to be useful for Real Estate sales, where the winning bidder might perhaps have 48 hours to produce funds for a down payment as is the case in many HUD sales. While the auction is frozen, bidding activity will be allowed to continue unfettered to include adding, modifying or deleting bids. If the auction is to be unfrozen, a restart time will be determined and announced, and when reached, the auction will resume.

Sellers will be allowed to mark an auction so that pre-screening of bidders is required. If this option is chosen the seller must include an Authorization Policy when posting the item 10, which describes what a potential bidder must do to meet the seller's requirements to permit bidding. A whitelist as well as a blacklist will be available for sellers to expedite frequent repeated requests by bidders. This intended to give the seller the ability to pre-screen suitable buyers for auctions where buyer suitability will impact the sale, as is the case with real estate, high priced items or pets.

Sellers will be allowed to mark an auction as private. Private auctions will only be known and visible to those users to whom the seller has granted permission to see and bid.

Bidding

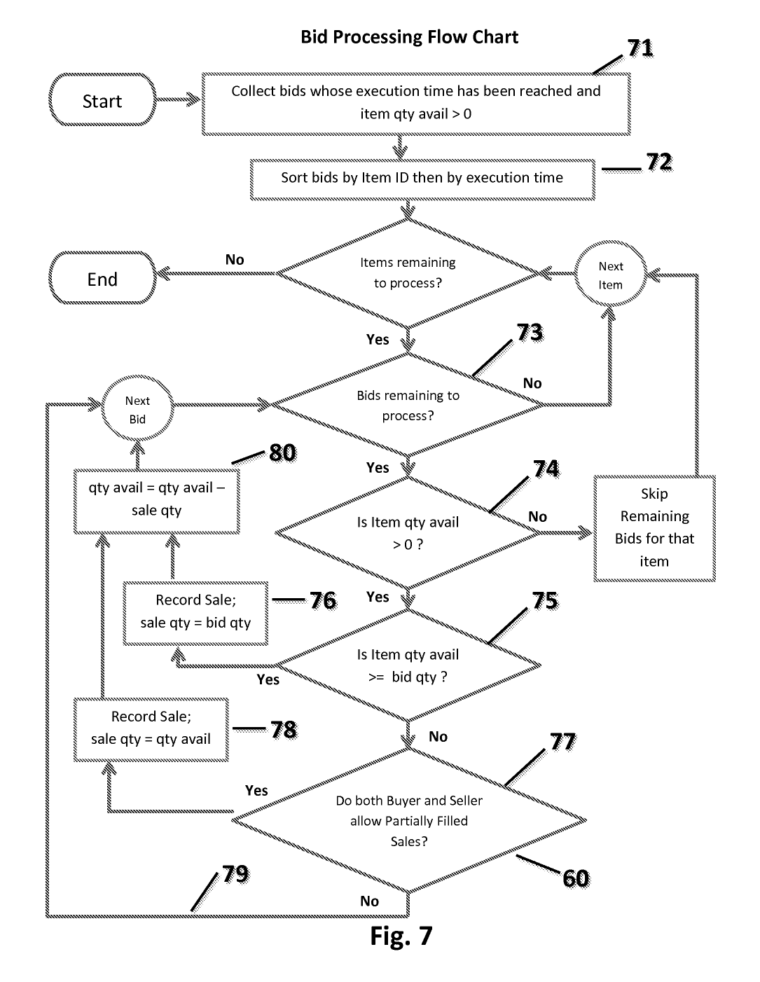

Bidders can view all pertinent item details by viewing the item's main page (FIG. 3), although it's look and appearance may vary. Bidders will always have the option to “Buy It Now” 31 at the current price point, wait for their desired price point to occur, or bid on their desired price point by clicking on the appropriate “Bid!” link in the respective BidBlock. Bidders will be directed to a confirmation screen, and after confirming their bid, they will ‘own’ that bid block. The bids are stored in a database bid table and include the item ID and the bid execution time which will be used in the selling algorithm (FIG. 7).

In the case of multiple lot items, bidders/buyers for multiple lots will be able to specify quantity (up to the seller's limit per person) and will be allowed to dictate an ‘all or none’ criteria. If opted for, the “all or none” criteria will prevent a buyer from getting a partial order filled. This could be useful in the case where a buyer might want four tickets to a concert, and would not want to purchase if there were only 3 tickets remaining. For bids where the “all or none” provision is opted for and prevents a sale, that bid will be continually passed over until and unless the buyer changes his bid or the seller restocks the item.

Bidders will be able to change or cancel their bid at any time. Multiple bidders can occupy a BidBlock, but the priority is given to the bidder who bid on that block first (FIFO).

All Bidding activity will be recorded in a BidHistory table. This will be available to Bidders for dispute resolution or for post auction analysis.

There are additional embodiments of this invention's bidding process that may be optionally employed by the bidder if allowed by the seller or the site administrator:
Anonymous bidding, where the bid is publicly viewable, but not the bidder's username.
Invisible bidding, where the bid does not appear publicly.
Proxy bidding, where a bid is automatically adjusted up to the bidders limit when outbid by another bidder.
Conditional Bidding/Buying (lot items), where your bid or purchase can be automatically adjusted to match your desires. One instance might be to purchase when half of the items have sold. Or to automatically adjust your bid in an attempt to be the lowest successful bidder, although due to FIFO mechanization this does not guarantee a sale.

Item Display

The Item Page (FIG. 3) displays all information regarding that auction item. There are 6 major sections, although their appearance and data displayed may vary depending on the template:
Ladder 32—contains a “Buy It Now” option, quick overview of the starting price, pace, current price, and quantity available (if applicable). A countdown clock counts down to the time of the next price reduction.
Pictures 33—a bock that displays all of the pictures and videos provided for the auction.
Leaderboard 34—a table showing the current rank and status of each active bid. This useful summary of bidders and standings has not occurred in any embodiment of prior art. It is very similar to a golf tournament leaderboard. It displays a ‘Cut Line’ 35: above this line, bidders will win the item(s) 36, and below this line, bidders will not 37. Partial orders may occur and will be displayed AJAX (Asynchronous Javascript and XML) technologies will allow this board to be updated when a change occurs, alleviating the need for clients to refresh their screen to receive the latest bid standings.
Social Board 38—a place for users to post comments like an online Bulletin Board forum. Users will have the opportunity to link their posts to their Facebook, Twitter or other social accounts. AJAX technologies will allow for real time updates to posted comments.
BidBlock Table 39—the tabular representation of each BidBlock price point. The buyer can choose the format they prefer.
Narratives and Policies 40—More item details, including seller policies regarding bid authorization (if selected by the seller), shipping, payments, and returns.

Invention BidBlock Logic and Mechanization

Given the seller's desired parameters, the BidBlocks are created based on mathematical rules with ‘n’ representing the ordinal number of price reductions. Constraints will limit the number of BidBlocks to a reasonable amount so that you don't have an unnecessarily large number of possible price points. The first BidBlock (n=0) is created at full price and lasts from the ‘Time Visible’ to the start of the first price reduction block. At the end of the delay, BidBlock 1 is created which lasts the time step, with the price decremented by one step price amount. “n” is incremented by one, and a new BidBlock is created in the same fashion. This continues as long as the BidBlock price is at or above the floor price. The last BidBlock does not have an end time, and will last indefinitely until the item is bought or the auction is cancelled.

The method is best explained by demonstrating a sample set of seller parameters:

| Creation Time: | 06:12 (24 hr. clock) |
|---|---|
| Starting Price: | $10 |
| Start Time: | 12:00 hours. |
| Price Schema: | Linear, $1/hour |
| Floor Price: | $4 |

The invention will create the following BidBlocks:

| | Time | Time | | | |
|---|---|---|---|---|---|
| BidBlock n | Start | End | Price | % off | Notes |
| 0 | 06:12 | <12:00 | 10 | 0 | |
| 1 | 12:00 | <13:00 | 9 | 10 | Price(n) = StartPrice − |
| 2 | 13:00 | <14:00 | 8 | 20 | (n × PriceStep) |
| 3 | 14:00 | <15:00 | 7 | 30 | % off = 100 × |
| 4 | 15:00 | <16:00 | 6 | 40 | (StartPrice − Price(n))/ |
| 5 | 16:00 | <17:00 | 5 | 50 | StartPrice) |
| 6 | 17:00 | ? | 4 | 40 | The Price Floor was |
| | | | | | reached. After 17:00, |
| | | | | | BidBlock 6 will remain |
| | | | | | active ad infinitum until |
| | | | | | the item is sold or the |
| | | | | | auction is cancelled. |

Below are four examples of how typical sellers might adjust the invention's parameters to suit their objectives for that item.

### EXAMPLE #1

A student would like to sell his Ford Gremlin within 20 days before he spends a semester abroad. His asking price is $5000, and he has an absolute floor of $3000. He selects a delay of 10 days and chooses a price reduction pace of $200/every day. The invention will generate a BidGrid with 10 BidBlocks, which will span 10 days. The floor price will be reached on the 20th day of visibility, unless a bid wins prior to that time.

### EXAMPLE #2

A homeowner would like sell within 90 days during the peak selling season. Her asking price is $200,000, and her floor is $140,000. She decides to commence her price reductions at 1 pm 30 days after posting, to allow time for advertising. She chooses a pace of $1000/day. This results in the creation of 60 BidBlocks (from $200 k down to $140 k) which will result in her floor being reached on the 90^{th} day of visibility (30 day delay, plus 60 days of price reductions).

### EXAMPLE #3

A computer dealer wishes to sell a lot of 20 laptops with a limit of 2 per buyer. He already has a large email list, and sets the auction to start 1 day after the number of interested buyers reaches 40. He sets an aggressive start price of $399, and in the fashion of a quick sale, sets the price to reduce at $1/minute to a floor of $299. This results in a BidGrid with 100 BidBlocks spanning 100 minutes.

### EXAMPLE #4

A couple has concert tickets but can't attend. The seats are good, so they start at face value or $100. The reductions are timed to reduce $5 every six hours and be at their floor price of $20 twelve hours before the start of the concert. They figure that even $20 will be better than 0, which is what the tickets will be worth after the concert starts. Below that amount, they've decided that they'll just give the tickets to some friends.

### EXAMPLE #5

(amortized price schedule) John has a watch that he'd like to sell for $200. He's not in a hurry and chooses an amortized reduction schema of 1% per day with a floor of $100. This will result in BidBlocks of $200, $198, $196.02, $194.06, $192.12, $190.20, etc. down to (but not below) his floor of $100.

Winning Bids

At the start of each server request, or as network traffic dictates, the algorithm for determining winners will be run (FIG. 7). The bid table in the database holds both the BidBlock ‘n’ number and the bid execution time. The program will first find all bids where the item quantity is >0 and the bid execution time has been reached 71. These bids are grouped by item ID and sorted by bid execution time 72. The bids for each item are then iteratively examined in order of the bid execution time 73. If the item quantity is 0, then the loop is exited, the remaining bids are skipped, and the bids for the next item are processed 74. Each bid is first checked against the item quantity available 75. If the quantity available is greater than the bid quantity, the sale is processed with the sale quantity=bid quantity. If the quantity available is less than the bid quantity, we have a possible partial fill sale situation. If partially filled orders are allowable by both the Seller and the Buyer 77, the Sale is processed with the sale quantity adjusted to be equal the quantity available 78. If partial orders are not allowed, the bid is skipped and the next bids for that item are processed 79. The quantity available is finally reduced by the sale quantity and the next bid is processed 80.

With the winning bid recorded, the two parties have agreed to a sale item, amount and price. The invention will then track the progress of the sale until each party has fulfilled their obligations. Disputes will be tracked and resolved. Sales statistics will be tracked to score the reliability and dependability of both the Seller and the Buyer.

Additional Capabilities:

There are numerous additional capabilities in numerous additional embodiments of this invention.

Items can be on a user's watch list or list of favorites.

Users may create a want list of items that are currently not for sale by any seller

Registered Users will be able to post comments for each auction in the same manner as an online forum. Users will have the option to link posts to their Facebook, Twitter or other social accounts. (FIG. 1:#4)

Any number of email or mobile app push notification options are possible:
When a new item gets posted in a certain directory or with certain keywords.
When a particular item or any item gets discounted to a certain price or lower.
When a favorite seller posts an item.
When an item is posted for sale within a certain geographic distance from home

Data on users' bidding patterns can be amassed to provide scoring on various bidding statistics, much in the same way that video gamers score themselves. These scores could be openly displayed for each user or remain private. These scores and statistics could include but are not limited to:
Winning Percentage: (# Auctions Bid on)/(# Auctions Won)
Average Discount for each auction won.
Average Number of Bid changes per auction.
Resolve (# Bids that give you the lead/# bid changes total)

In one embodiment, individual auctions can be miniaturized and modified to fit on a predetermined banner size displayable on another website. Pop-up HTML and AJAX technologies can give the banner full functionality, or refer an interested user to the originating auction site to continue bidding or enhanced functionality. This will allow merchants to employ Dutch auction marketing on their own website, encouraging users to return and keep track of the sales results.

In another embodiment, this invention is retooled as a plug-in designed to work on other ecommerce vendor storefront websites, such as shopify.com.

All of the capabilities of the Invention can be ported to mobile devices either through approved apps or specialized HTML interface embodiments, affording mobile users full functionality.

1. A method of conducting an online auction with automatic price adjustments comprising the steps of:
(a) interfacing via a network between multiple client computing devices and a Web server running software applications and accessing a database to deliver requested content;
(b) establishing the starting price, floor price, and reserve price for the item, as well as descriptions, policies, instructions and procedures;
(c) establishing the starting quantity;
(d) selecting the pricing algorithm;
(e) selecting the criterion to start the pricing algorithm;
(f) accepting current purchase orders based on the current calculated price;
(g) accepting bids for purchase orders for price points that will occur in the future.

2. The method of claim 1 wherein the selected pricing algorithm of step (d) linearly reduces the price a set amount for each set interval of time from the start price down to but not going lower than the floor price.

3. The method of claim 1 wherein the selected pricing algorithm of step (d) iteratively reduces the price a set percentage in a compounding manner for each set interval of time from the start price down to but not below the floor price.

4. The method of claim 1 wherein the selected pricing algorithm of step (d) may, at the seller's option, be delayed or extended a set time period upon each purchase activity, effectively allowing the pricing algorithm to resume only after a set time period without purchase activity.

5. The method of claim 1 wherein the selected pricing algorithm of step (d) may, at the seller's option, have its time interval basis automatically overridden and substituted by a basis correlating to a desired sales rate, allowing for prices to automatically increase during periods of higher sales, remain steady during periods of optimum sales, or decrease according to the original pricing algorithm during periods of lower sales.

6. The method of claim 1 wherein the pricing algorithm of step (d) is used in combination with the starting price and the floor price to create a finite array of price points along with each price point's related data such as price, discount, n number, start time, end time, active bidders and their requested quantity and registered alerts.

7. The method of claim 6 wherein the array of price points is referenced to generate a graphical user interface (GUI) for each price point, allowing the bidder to perform any action related to that price point such as bidding, setting alerts, or viewing more details.

8. The method of claim 7 wherein the GUI of each price point may have its style or functionality altered by content, colors, borders, font effects or other means to allow bidders to quickly and easily assess that price point's status in various dimensions such as whether the price point is past, current or future, or whether the price point is occupied by bidders, or other metrics.

9. The method of claim 1 wherein the criterion of step (e) is set so that the pricing algorithm commences at a pre-determined time.

10. The method of claim 1 wherein the criterion of step (e) is set so that the pricing algorithm commences when consumer interest reaches a predetermined level.

11. The method of claim 10 wherein the level of consumer interest is scored by an algorithm based on measurable data points, such as numbers of bids, aggregate bid quantity requested vs. quantity for sale or numbers of views.

12. The method of claim 1 wherein buyers can either purchase at the current price, choose to wait for their desired price point to become active, or bid on their desired price point with their bid being recorded in a FIFO order of priority on that price point.

13. The method of claim 12 wherein bidders for multiple quantity items may also designate the quantity desired up to the seller's per person limit, and for the cases where they have requested a quantity greater than one, whether they will accept the sale of partial quantities less than requested.

14. The method of claim 12 wherein bids are recorded with an execution time, and processed at regular intervals to generate purchase orders for those bids whose execution time has been reached.

15. The method of claim 1 wherein the auction may be paused at the discretion of the seller and resumed at a later date.

16. The method of claim 1 wherein a single item auction may, at the seller's option, be ‘frozen’ after a sale is struck, and either finalized or resumed pending the outcome of the active sale.

17. The method of claim 1 wherein the seller may optionally require that bidders meet seller defined criteria before being granted permission to bid.

18. The method of claim 16 wherein the seller may create a whitelist, or conversely a blacklist of bidders to automate the granting of bidding permissions.

19. The method of conducting an auction of claim 1 wherein bidders are ranked and placed on a leaderboard depicting their rank order and relative status, and in the case of auctions with a multiple limited quantities, visually demarking bidders who will at the current point in time either be awarded a sale or not.

20. The method of conducting an auction of claim 1 wherein sales that are struck below the seller's reserve price are granted a pending status, where it becomes the seller's option to either accept or reject the sale without prejudice.

21. The method of conducting an auction of claim 1 wherein the core functionality is programmatically embedded on a third party host website, allowing for the host website to benefit from the excitement, attraction and user return rates of dynamic pricing while keeping the visitor at the host site.

22. The method of conducting an auction of claim 1 wherein the core functionality is ported to use as a plug-in application for a third party merchant hosting service.
